(19) United States
(12) Patent Application Publication
(10) Pub. No.: US 2008/0144788 A1
(43) Pub. Date: Jun. 19, 2008

(54) Method of performing voice communication in mobile terminal

(75) Inventors: Jeong Min You, Yongin-si (KR); Seung Gun Park, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/948,465

(22) Filed: Nov. 30, 2007

(30) Foreign Application Priority Data
Dec. 13, 2006 (KR) 2006-0127022

(51) Int. Cl. H04M 11/00

(52) U.S. Cl. 379/93.15

(57) ABSTRACT

A method of performing communication in a mobile terminal is provided. The method includes recording a voice phone number of a second party while communicating with the first party, reproducing the recorded voice phone number when a request for voice communication is input, recognizing the reproduced voice phone number, dialing the recognized voice phone number to call the second party, and performing communication with the second party when the second party receives the call.

### PRIORITY

This application claims priority under 35 USC § 119 to an application entitled “METHOD OF PERFORMING VOICE COMMUNICATION IN MOBILE TERMINAL” filed in the Korean Intellectual Property Office on Dec. 13, 2006 and assigned Serial No. 2006-0127022, the contents of which are incorporated herein by reference.

### BACKGROUND OF THE INVENTION

1. Field of the Invention

The present invention relates generally to a method of performing communication in a mobile terminal, and more particularly, to a method of performing voice communication using a voice phone number spoken by a counter party.

2. Description of the Related Art

In general, a method of calling in a mobile terminal is performed by dialing a phone number of a receiver and selecting a receiver in a phone book or using an abbreviated number. In this manner, a user selects a name or a phone number of the receiver using a phone number search function, and generates a communication instruction, thereby performing communication.

Further, the user may ask a counter party for a phone number of another party while communicating. Particularly, the user may ask the counter party for a phone number, a phone number may be spoken by the counter party and written on a memo or memorized by the user, or a phone number may be input through a key pad and stored by pressing a specific key. For this, communication may be temporarily interrupted.

Accordingly, a method of recording a voice spoken by the counter party and dialing, when communication is terminated, a recorded voice phone number, is required.

### SUMMARY OF THE INVENTION

The present invention has been made in an effort to solve the above problems, and the present invention provides a method of performing communication using a voice phone number spoken by a counter party while communicating in a mobile terminal.

The present invention provides a method of recording a received voice phone number when a recording instruction is input while communicating in a mobile terminal, recognizing the recorded voice phone number when a request for communication is input after recording is terminated, and automatically executing a communication service.

The present invention provides a method of recording a received voice phone number when a recording instruction is input while communicating in a mobile terminal, converting the voice phone number to a character phone number after the recording of the voice phone number is terminated, displaying and correcting the converted character phone number, and automatically dialing the converted character phone number, when a request for communication is input, thereby performing a communication service.

The present invention provides a method of recording a received voice phone number when a recording instruction is input while communicating in a mobile terminal, reproducing the recorded voice phone number when a request for communication is input after the recording of-the voice phone number is terminated, recognizing the voice phone number input through a microphone, and automatically dialing the recognized voice phone number, thereby performing a communication service.

In accordance with the present invention, a method of performing communication in a mobile terminal includes recording a voice phone number of a second party while communicating with a first party, reproducing the recorded voice phone number when a request for voice communication is input, recognizing the reproduced voice phone number, dialing the recognized voice phone number to call the second party, and performing communication with the second party when the second party receives the call.

In accordance with the present invention, a method of performing communication in a mobile terminal includes recording a voice phone number of a second party while communicating with the first party, reproducing the recorded voice phone number, recognizing the reproduced voice phone number and converting the recognized phone number to a character phone number, dialing the converted character phone number to call the second party when a request for voice communication is input, and performing communication with the second party when the second party receives the call.

In accordance with the present invention, a method of performing communication in a mobile terminal includes recording a voice phone number of a second party while communicating with the first party, reproducing the recorded voice phone number when a request for voice communication is input, recognizing the voice phone number of the second party input by a user of the mobile terminal through a microphone, dialing the phone number of the second party to make a call, and performing communication with the second party when the second party receives the call.

### BRIEF DESCRIPTION OF THE DRAWINGS

The objects, features and advantages of the present invention will be more apparent from the following detailed description in conjunction with the accompanying drawings, in which:

FIG. 1 illustrates a configuration of a mobile terminal according to the present invention;

FIG. 2 illustrates a configuration of a voice processor of the mobile terminal of FIG. 1;

FIG. 3 illustrates a method of performing a voice communication service according to a first embodiment of the present invention;

FIG. 4 illustrates a process of registering calling party information in a phone book in the method of FIG. 3;

FIG. 5 illustrates a method of performing a voice communication service according to a second embodiment of the present invention;

FIG. 6 illustrates a process of correcting a converted text in the method of FIG. 5; and

FIG. 7 illustrates a method of performing a voice communication service according to a third embodiment of the present invention.

### DETAILED DESCRIPTION OF THE PREFERRED EMBODIMENTS

Preferred embodiments of the present invention are described with reference to the accompanying drawings in detail. The same reference numbers are used throughout the drawings to refer to the same or like parts. Detailed descriptions of well-known functions and structures incorporated herein may be omitted for the sake of clarity and conciseness.

In the following description, “a user of a mobile phone” indicates a calling party performing voice communication using a mobile terminal. “A first party” indicates a counter party speaking a phone number of another party while communicating with a user of the mobile terminal. “A second party” indicates an owner of a phone number spoken by the first party and receiving a call from the user of the mobile terminal by voice dialing by the user. “A voice phone number” indicates a phone number expressed by a voice. “A character phone number” indicates a character phone number to which a voice phone number is converted.

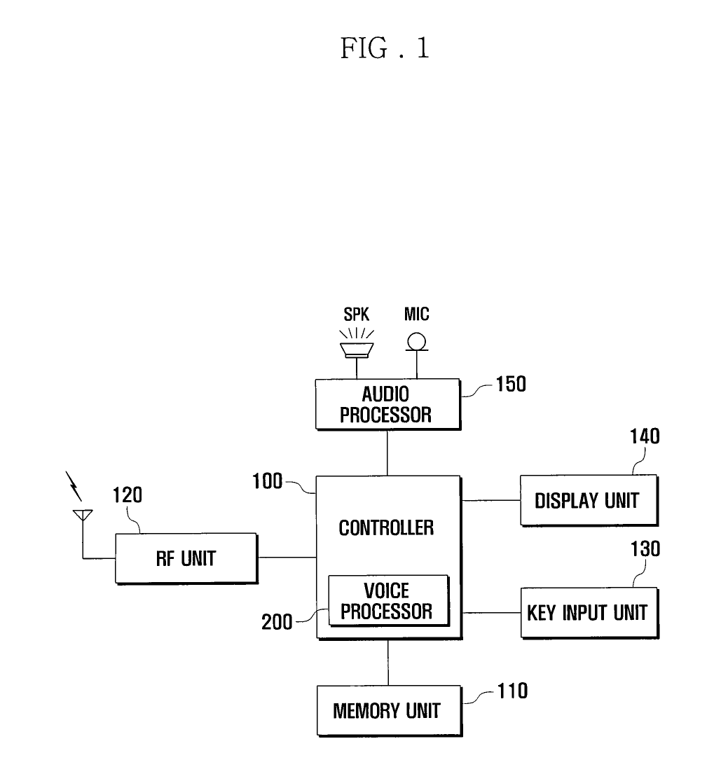

FIG. 1 illustrates a configuration of a mobile terminal according to the present invention.

Referring to FIG. 1, an RF (Radio Frequency) unit 120 performs a wireless communication function of a mobile terminal. The RF unit 120 includes an RF transmitter for up-converting a frequency of a signal to be transmitted and amplifying the signal, and an RF receiver for down-converting a frequency of a received signal and low-noise amplifying the signal. The key input unit 130 includes keys for inputting numeral and character information and a function key for setting various functions. The key input unit 130 further includes a record key for recording a received voice signal, and a reproducing key for performing a communication using the recorded voice signal.

The controller 100 controls general operations of a mobile terminal. The controller 100 includes a data processor having a codec consisting of an encoder for encoding a signal to be transmitted, a decoder for decoding a received signal, a modem consisting of a modulator for modulating the encoded signal for transmission and outputting the modulated signal to the RF unit 120 and a demodulator for demodulating a modulated received signal input by the RF unit 120 and outputting the demodulated signal to the decoder.

The controller 100 further includes a voice processor 200 for performing communication with a received voice signal. The voice processor 200 recognizes a received voice signal, converts the recognized voice signal to character data, and generates information such as a phone number or a calling party name from the character data. The voice processor 200 can perform a communication function using the generated phone number by the control of the controller 100.

The memory 120 includes program and data memory. The program memory stores an operation program of the mobile phone and a program for executing communication by performing a voice dialing function according to the present invention. The data memory stores data generated while performing the program, and includes a conversion table for converting a voice to a text, a voice memory for storing voice data received in a record mode, and a phone book for storing phone numbers and calling party names.

The display unit 140 displays a state of, and information processed in the mobile terminal, by the control of the controller 100. The display unit 140 can use a Liquid Crystal Display (LCD), in which case the display unit 140 includes an LCD controller, memory for storing display data, and LCD display element. If the LCD uses a touch screen, the display unit 140 may be operated as an input unit. The audio processor 150 processes a transmitted or received audio signal.

A mobile terminal according to the present invention having the above-described construction can record a voice signal generated by a counter party while communicating, and perform an automatic communication function using the recorded voice signal. Here, a voice signal may be a phone number. That is, a user of the mobile terminal requests a counter party for a phone number of a specific calling party while communicating, and presses a record key of the key input unit 130. Accordingly, the phone number received from the counter party through the RF unit 120 is stored in a voice memory of the memory unit 110. If a reproducing key of the key input unit 130 is pressed when the user terminates communication or is performing communication, the controller 100 outputs phone number voice data stored in the voice memory of the memory unit 110 to the voice processor 200. The voice processor 200 recognizes the reproduced phone number voice signal, dials the recognized phone number, and performs a communication function. As described above, during communication, a phone number spoken by a counter party is recorded, the recorded voice phone number is dialed and a communication function is performed.

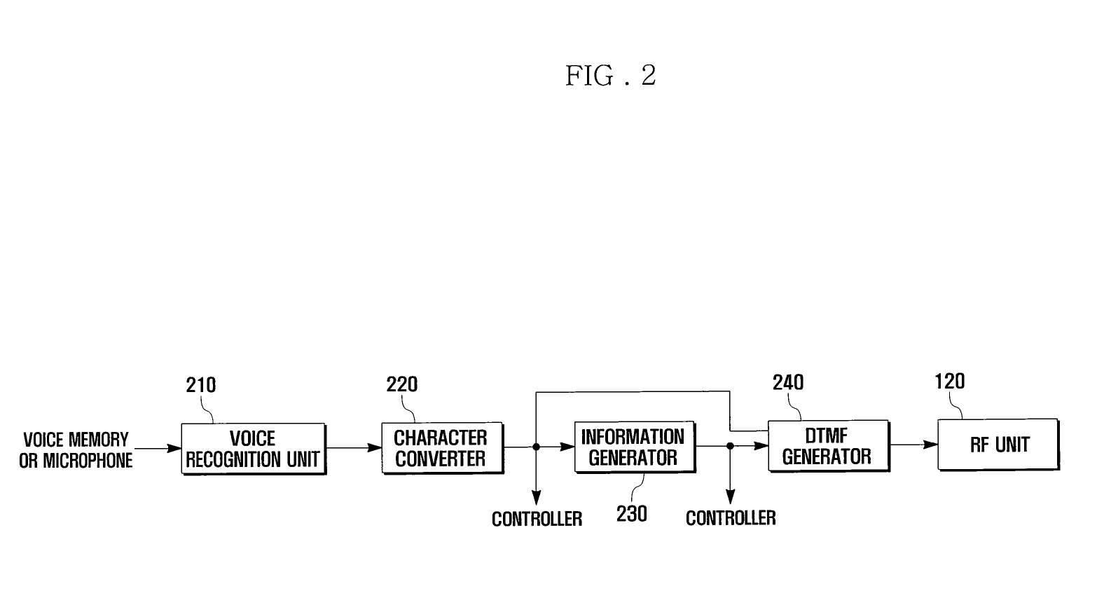

FIG. 2 illustrates a configuration of the voice processor 200 of FIG. 1.

Referring to FIG. 2, a voice recognition unit 210 recognizes a received voice signal and generates voice data. A character converter 220 converts the recognized voice data to character data. An information generator 230 converts character data output from the character converter 220 to a phone number. A Dual-Tone Multi-Frequency (DTMF) generator 240 converts the phone number to a DTMF signal that it outputs to the RF unit 120. The voice processor 200 may be provided in the controller 100, as shown in FIG. 1, or may be entirely or partially provided outside the controller 100, as shown in FIG. 2. As described above, the voice processor 200 converts speech to text by recognizing a voice signal and converting the recognized voice signal to character data, converts the converted character to a DTMF signal and performs an automatic dialing function using the DTMF signal.

It is assumed that the voice processor 200 recognizes an English voice and converts the recognized English voice to character data. This voice processor 200 can be embodied in a different method according to a specific language. That is, since languages have different characteristics, a method of recognizing a voice according to the characteristics and converting a recognized voice to character data may differ between languages. In the present invention the following method of recognizing voice can be used.

Voice recognition of the Korean language is performed by using a decoder (acoustic decoder) for recognizing a phoneme/syllable or a word in a voice signal, a sentence by synthesizing a result in which a phoneme/syllable or a word is recognized, and philological information. The voice recognition unit 210 can be a decoder for recognizing a phoneme/syllable or a word and outputting the recognized phoneme/syllable or word as voice data, and the character converter 220 converts the recognized voice data to character data. Therefore, the character converter 220 converts the realized voice data to character data according to an English character system. A voice signal input to the voice recognition unit 210 may be a phone number in a communication mode and may be information such as a phone number and a calling party name in a phone book registration mode.

In this case, a phone number spoken by a counter party can be in various forms. If a phone number is, for example “010-234-6789,” the counter party can speak the phone number in various forms, such as “zero one zero two three four six seven eight nine” and “oh one oh dash two three four dash six seven eight nine”. A voice signal received in various forms as described above should be able to generate numeral data such as “010-2345-6789.” Further, if a phone number is, for example “010-800-1000,” “800” may be spoken as “eight oh oh”, “eight hundred,” or “eight double oh,” and “1000” may be spoken as “one oh oh oh”, “ten double oh”, and “one triple oh”, by the counter party.

A phone number variously received as described above should be able to be converted to numeral data. The information generator 230 performs a function of converting phone number data variously generated as described above according to a phone number system. That is, if character conversion data including numeral information are input, the information generator 230 extracts only character data related to a numeral, and removes the remaining character data. The information generator 230 generates a converted character into a phone number of numerals using Table 1.

TABLE 1

| Character data | | Phone number |
|---|---|---|
| Zero | oh | 0 |
| One | | 1 |
| Two | | 2 |
| Three | | 3 |
| Four | | 4 |
| Five | | 5 |
| Six | | 6 |
| Seven | | 7 |
| Eight | | 8 |
| Nine | | 9 |

Further, when unit character data such as “thousand” and “hundred” are included in the numeral data, numeric data existing at the front or the rear of the unit character data is analyzed, thereby generating a phone number. That is, when numeral data is omitted at the rear of the unit character data, “0” is inserted into numeral data following the unit character (for example, in eight hundred, at the rear of ‘8’, ‘00’ is inserted, -and in one thousand, at the rear of ‘1’, ‘000’ is inserted). Further, if character data such as “double” or “triple” exist at the front of numeral data, numeral data positioned at the rear of the character data is repeatedly inserted (for example, double oh: 00 and triple oh: 000)

Thereafter, a phone number generated in the information generator 230 is converted to a DTMF signal in the DTMF generator 240 and output to the RF unit 120. When voice dialing is performed as described above, a base station forms a communication path with another party corresponding to the phone number, and thus the mobile terminal performs voice dialing of another party's phone number acquired while communicating and performs a communication service. When the communication service is terminated, the controller 100 controls the display unit 140 to display a window for inquiring whether to register the phone number in a phone book, and inputs, if a phone book registration function is selected, information associated with the phone number (for example, a name of the owner of the phone number) using the key input unit 130 or by a voice using a microphone (MIC). If a voice signal is input through the MIC, the controller 100 controls the voice processor 200 to perform a voice recognition process and registers the information associated with the phone number generated in the voice processor 200.

In a first embodiment of the present invention, a voice phone number received while communicating is recorded according to a recording instruction, and if a calling is requested by the user after the recording is terminated, the recorded voice phone number is recognized, and a calling communication service is automatically performed.

Therefore, in a method of performing communication in a mobile terminal according to the first embodiment, a voice phone number of a second party spoken by the first party while communicating with the first party is recorded, and when a request for voice communication is input by the user, the recorded voice phone number is reproduced, the reproduced voice phone number is recognized, the second party's phone number is automatically dialed, and when the second party receives the call, communication with the second party is performed.

In the method of recording the voice phone number according to the first embodiment, when the first party speaks the second party's phone number, recording is started, and when the first party terminates speaking the second party's phone number, recording is terminated.

In a method of dialing the voice phone number, the voice phone number is recognized, and the recognized voice phone number is converted to a character phone number, character data that is not related to a numeral and unit character data is removed from the converted character phone number, the numeral and unit character data is analyzed, and thus a phone number is generated, and the character phone number is converted to a DTMF signal and dialed.

In the first embodiment, if a request for voice communication is input while communicating with the first party, communication with the first party is released and the recorded voice phone number is reproduced. Further, a request for voice communication may be input after communication with the first party is released.

Further, if communication with the second party is terminated, a phone number of the second party may be registered in a phone book, and when a request for registering calling party information in the phone book is input, calling party information is registered in a phone book together with the phone number. In this case, the calling party information includes a calling party name, and if the calling party information is input by a voice, the input voice is recognized and the recognized voice is converted to character data, which is registered.

In a second embodiment of the present invention, when a recording instruction is input while communicating, a received voice phone number is recorded. After recording is terminated, the voice phone number is converted to a character phone number, and the converted character phone number is displayed (if a character converting error is generated, a character error may be corrected). When a request for calling communication is input, the converted character phone number is automatically dialed, whereby a calling communication service is performed.

In the method of performing communication in a mobile terminal according to the second embodiment, a voice phone number of a second party received while communicating with the first party is recorded, the recorded voice phone number is reproduced, the reproduced voice phone number is recognized, the recognized voice phone number is converted to character data, and when a request for voice communication is input, the second party phone number converted to character data is dialed, and when the second party responds, communication with the second party is performed.

The method of recording a voice phone number according to the second embodiment is performed by starting recording when the first party speaks the second party phone number, and terminating the recording when the first party terminates speaking the second party phone number.

In the second embodiment, after a voice phone number is converted to a character phone number, the character phone number can be corrected by displaying the converted character phone number, displaying a position of a character to be corrected according to an input key, and correcting, when a character is input, the uncorrected character at the displayed position.

A method of dialing the voice phone number is performed by recognizing the voice phone number, converting the recognized phone voice number to a character phone number, removing character data that is not related to a numeral and unit character data from the converted character phone number, analyzing numeral and unit character data, generating a phone number, converting the generated character phone number to a DTMF signal, and dialing the character phone number.

In the second embodiment, if a request for voice communication is input while communicating with the first party, communication with the first party is released and the recorded voice phone number is reproduced. Further, a request for voice communication may be input after communication with the first party is released.

Further, when communication with the second party is terminated, a window for inquiring whether to register the second party's phone number in the phone book is displayed, and if a request for registering the second party's phone number in the phone book is input, the input calling party information is registered in the phone book together with the phone number. In this case, the calling party information includes a calling party name, and if the calling party information is input by a voice, the input voice is recognized, the recognized voice is converted to character calling party information, and the converted character calling party information is registered.

In a third embodiment of the present invention, if a recording instruction is input during communication, a received voice phone number is recorded. After recording is terminated, a request for communication is input, the recorded voice phone number is reproduced, a voice phone number input through the MIC is recognized, the recognized phone number is automatically dialed, and a calling communication service is performed.

For example, a voice phone number of the second party received while communicating with the first party is recorded, and when a request for voice communication is input, the recorded voice phone number is reproduced, and a voice phone number input through the MIC is recognized, the recognized second party's phone number is automatically dialed, and when the second party responds, communication with the second party is performed.

In the third embodiment, the voice phone number in the mobile terminal may be a voice phone number of a set form. A method of dialing the voice phone number is performed by recognizing the voice phone number, converting the recognized voice phone number to a character phone number, converting the character phone number to a DTMF signal, and dialing the character phone number.

Further, when communication with the second party is terminated, a window for inquiring whether to register the second party's phone number in the phone book is displayed, and when a request for registering the second party's phone number in the phone book is input, the input calling party information is registered in the phone book together with the phone number. In this case, the calling party information includes a calling party name, and when the calling party information is input by a voice, the input voice is recognized, and the recognized voice is converted to character calling party information, which is registered.

A calling communication service according to the first, second and third embodiments of the present invention is described in detail hereinafter.

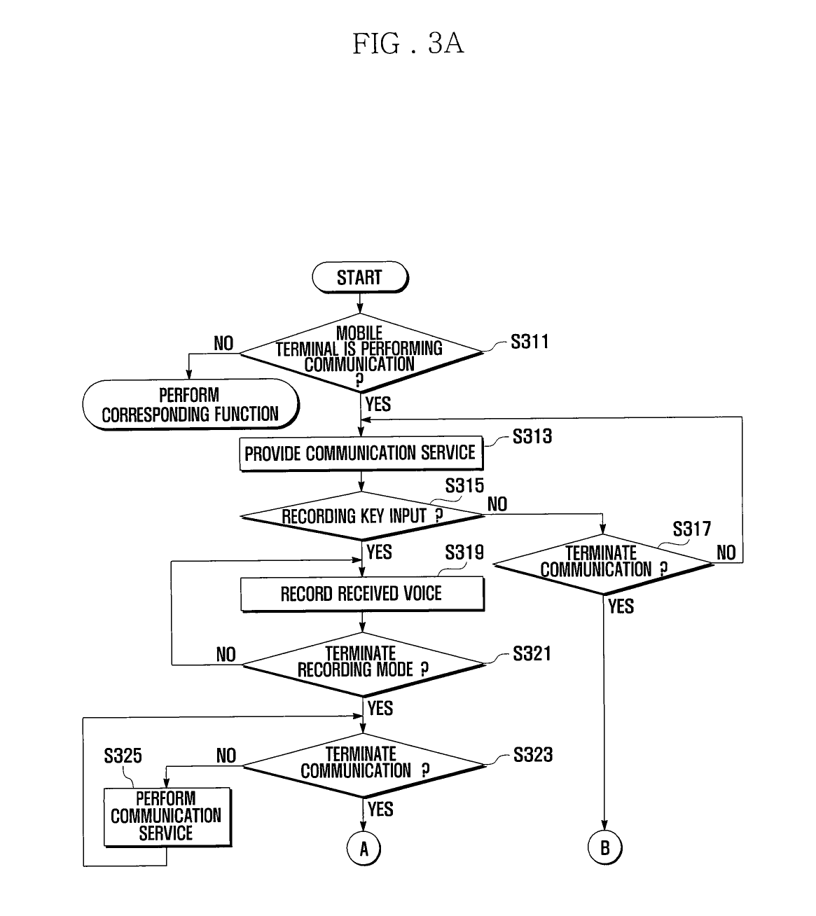

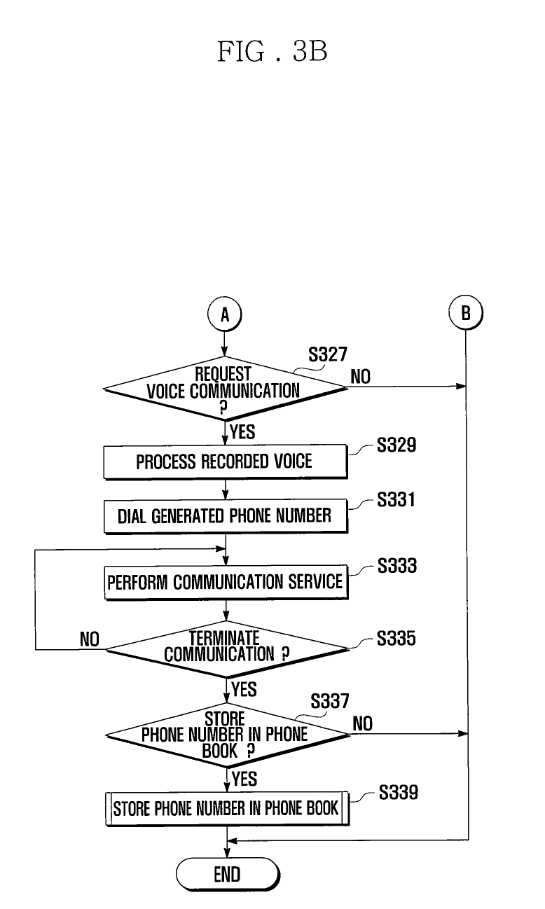

FIG. 3 is a flowchart illustrating a method of performing a voice communication service according to a embodiment of the present invention.

Referring to FIG. 3, the controller 100 determines whether the mobile terminal is performing communication in step S311. If the mobile terminal is not performing communication, another function is performed. If the mobile terminal is performing communication, the controller 100 performs a communication service in step S313. In a communication service state, the controller 100 encodes and modulates a voice signal generated in the MIC, outputs the encoded and modulated voice signal to the RF unit 120, demodulates and decodes a voice signal received from the RF unit 120 and outputs the demodulated and decoded voice signal to the speaker SPK.

The controller 100 determines whether a recording key is input by a user in step S315. If a recording key is not input, the controller 100 determines whether an instruction for terminating communication with a counter party is input in step S317. If so, the controller 100 terminates communication with the counter party. If not input, the process returns to step S313 and the controller 100 continues to perform the communication service.

While performing communication at step 313, the user of the mobile terminal may request the counter party for another party's phone number. In this case, when the counter party speaks the other party's phone number, the user of the mobile terminal can record the received other party's voice phone number, and perform communication using the recorded voice phone number.

The key input unit 130 may include a recording key and a reproducing key, both of which may be formed as independent keys or may use an unused specific key (for example, a confirmation key, cancellation key, and direction key).

If a recording key is input at step S315, the controller 100 records a received voice signal and stores the received voice signal at a voice memory of the memory unit 110 in step S319. It is assumed that the voice memory is a memory in which the user stores a voice signal while communicating. In this case, the recorded voice signal may be a phone number generated with the voice of the counter party. While recording the voice signal, when the entire voice phone number spoken by the counter party is recorded, the user of the mobile terminal terminates a recording mode. The recording mode can be terminated by pressing a recording key, or alternatively a recording release key may be provided and a recording mode may be released by pressing the recording release key.

The controller 100 determines whether a recording mode termination instruction is input in step S321. If so, the controller 100 terminates the communication service. Therefore, the user of the mobile terminal can selectively record a phone number voice signal among various voice signals spoken by the counter party.

Thereafter, the user of the mobile terminal can automatically perform a calling communication function using a voice phone number stored in the voice memory. In this case, the calling communication function can be automatically executed using the recorded voice phone number while communicating or using the recorded voice phone number after communication is terminated. In this embodiment of the present invention, it is assumed that after communication is terminated, a voice dialing function is executed.

After the voice phone number is recorded, the controller 100 determines whether a communication termination instruction is input in step S323. If a communication termination instruction is not input, the controller 100 continues to perform a communication service with the counter party in step S325. If a communication termination instruction is input, the controller 100 determines whether a request for voice communication is input in step S327. In this case, the key input unit 130 may include a voice communication key, which may be formed as an independent key or may use a specific key (for example, a confirmation key and a cancellation key) that is not operated in a standby state.

If a voice communication key is input, the controller 100 processes the recorded voice. In more detail, the controller 100 outputs a voice phone number stored in the voice memory of the memory unit 110 to the voice processor 200, recognizes the voice phone number through the voice processor 200, and generates phone number information using the recognized voice phone number.

If a request for voice communication is input at step S327, the controller 100 controls the voice processor 200 to convert voice data stored in the memory unit 110 to a phone number form. That is, if a voice calling communication function is selected, the controller 100 identifies the stored voice data as a phone number and controls the voice processor 200 to convert the voice data to a phone number. After communication is terminated, if a phone book registration function is selected, the controller 100 identifies a voice input through the MIC or key data input through the key input unit 130 as an owner name of a phone number, and when the voice is input, the controller 100 controls the voice processor 200 to generate the name of the owner of the phone number.

If a request for voice communication is input at step S327, the controller 100 processes the recorded voice in step S329. In more detail, the reproduced voice phone number is recognized in the voice recognition unit 210, and the recognized phone number is converted to a character phone number in the character converter 220. The converted character phone number can be displayed in various forms according to the form with which the counter party speaks the phone number. The information generator 230 then converts the character phone number to a phone number that can be dialed by a voice. For example, when the recorded voice phone number is “oh one oh triple eight ninety seven double oh”, the information generator 230 generates numeral data “010 888 9700.”

After the phone number is generated as described above, the controller 100 dials the generated phone number in step S331. In more detail, the controller 100 controls the display unit 140 to display the generated phone number and controls the DTMF generator 240 to generate a DTMF signal of the corresponding phone number, then transmits the generated DTMF signal through the RF unit 120. The converted phone number is displayed in the display unit 140, and a process of generating a DTMF signal according to a user communication instruction may be further provided. This is because, if an error exists in the phone number data generated in the information generator 230, the process may enable the error to be corrected. In this case the user of the mobile terminal may determine whether a phone number displayed in the display unit 140 is correct, correct data in which an error exists, and perform a communication function.

After voice dialing is performed, when a response signal is received from a counter party, the controller 100 performs a communication service in step S333.

The controller 100 determines whether a request for terminating communication is input in step S335. If so, the controller 100 terminates the communication service in step 336 and determines whether a request for storing the phone number in the phone book is input in step S337 If a request for storing the phone number in the phone book is input, the controller 100 receives the dialed voice phone number and stores the phone number in the phone book in step S339. In this case, when the communication is performed by the voice dialing, the phone number of the counter party may not be stored in the phone book. Therefore, it is preferable to register the corresponding phone number in the phone book after the voice communication service is performed. Thereto, when the voice calling communication service is terminated, the controller 100 controls the display unit 140 to display a pop-up window for displaying a request for storing the phone number in the phone book. When the pop-up window is displayed, if the user selects to store the phone number in the phone book, the controller 100 controls the display unit 140 to display the phone number to be stored in the phone book, and recognizes information associated with the phone number input through the MIC or the key input unit 130 and registers the information in the phone book in step S339.

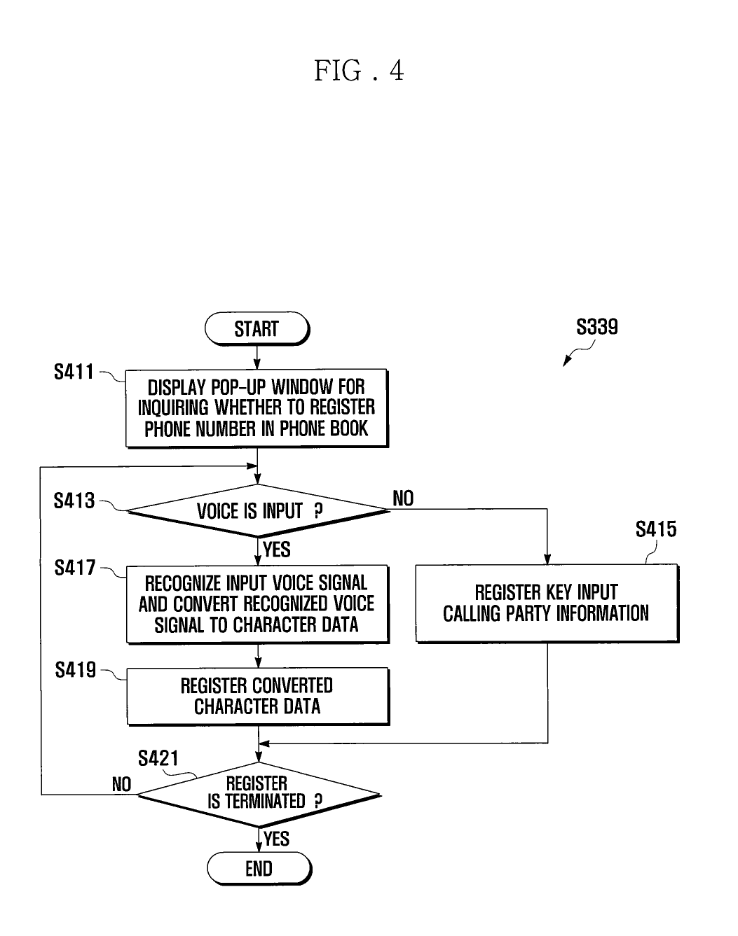

FIG. 4 illustrates a process of registering calling party information in a phone book at step S339 of the method of FIG. 3.

Referring to FIG. 4, the controller 100 controls to display a pop-up window for inquiring whether to register a phone number in a phone book after a voice calling communication function is performed in step S411. When the user selects a phone book registration function, the controller 100 controls the display unit 140 to display the phone number to be registered and to guide the user information for helping to input information associated with the phone number.

The controller 100 determines whether a voice is input in step S413. We enclosed a revised FIG. 4. If a voice is input through a MIC, the controller 100 controls the voice recognition unit 210 to recognize the input voice signal, and converts the recognized voice signal to character data in step S417. In this case, the received voice signal includes a calling party name, and the converted character data is processed after the voice signal is recognized. Therefore the controller 100 can register, when the voice recognition and character conversion processes are performed, information output from the character converter 220 as calling party information in the phone book without operating the information generator 230 of the voice processor 200.

The controller 100 controls the display unit 140 to display the converted character data, and registers the converted character data as calling party information in the phone book together with a phone number in step S419. In order to enable the user to correct the displayed calling party information, the text may be registered when a registration request instruction is input by the user.

If a voice is not input at step S413, the controller 100 generates calling party information according to key data input in the key input unit 130 and registers the calling party information in the phone book in step S415.

The controller 100 determines whether the calling party information is registered in the phone book in step S421. If the calling party information is registered in the phone book, the controller 100 terminates the process of registering a phone number and calling party information in the phone book after performing voice communication.

As described above, in the first embodiment of the present invention, a voice phone number received from a counter party while communicating is recorded, and when a request for voice communication is input, the recorded voice phone number is recognized, the recognized phone number is converted to phone number data, the phone number is dialed using the converted phone number data, and thus communication with another party is performed.

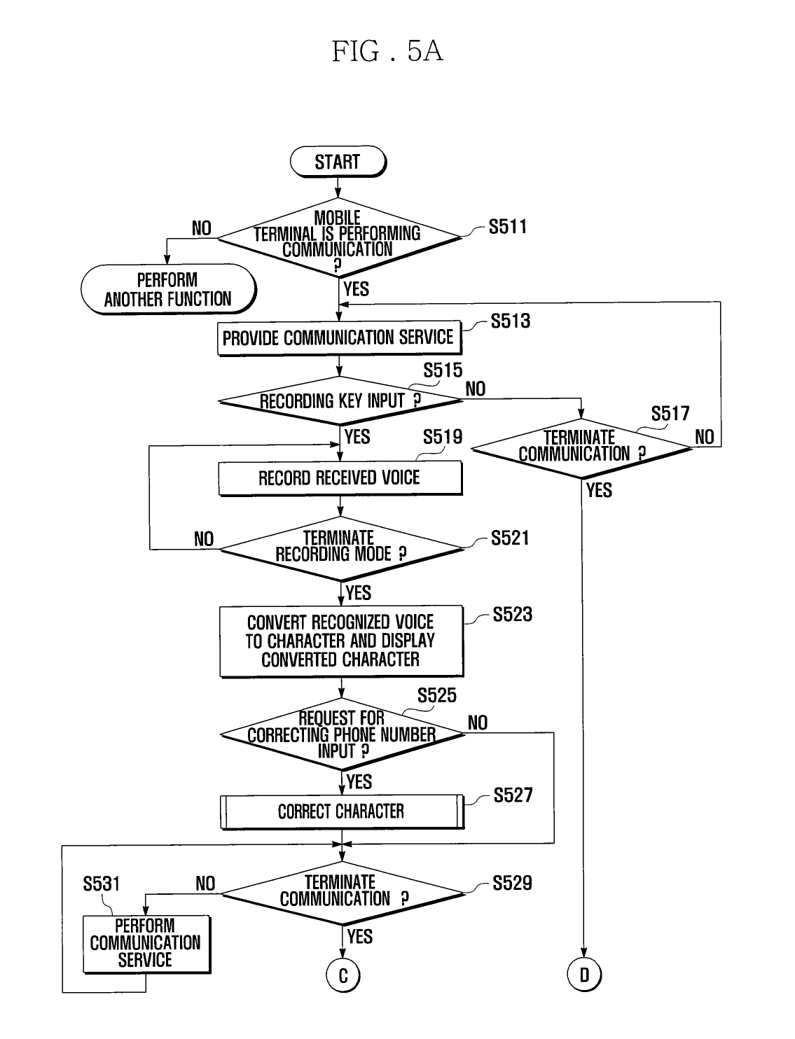

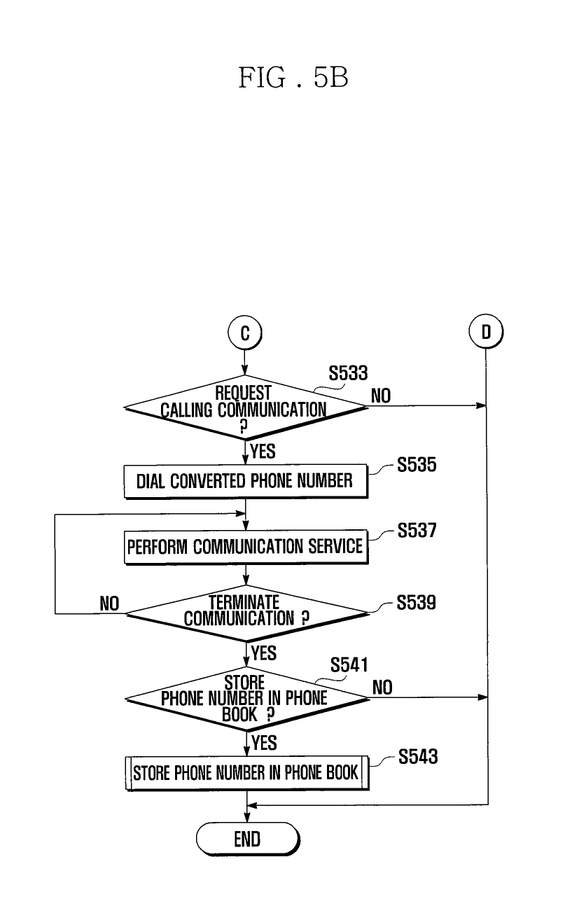

FIG. 5 illustrates a method of performing a voice communication service according to a second embodiment of the present invention.

Referring to FIG. 5, the controller 100 determines whether the mobile terminal is performing communication in step S511. We enclosed revised FIG. 5. If the mobile terminal is not performing communication, another function is performed. If the mobile terminal is performing communication, the controller 100 performs a communication service in step S513.

In a communication service state, the controller 100 determines whether a recording instruction is key input by a user in step S515.

If not key input, the controller 100 determines whether an instruction for terminating communication with a counter party is input in step S517. If an instruction for terminating communication with a counter party is input, the controller 100 terminates communication with the counter party. If an instruction for terminating communication with a counter party is not input, the process returns to step S513 and the controller 100 continues to perform the communication service.

If a recording instruction is input at step S515, the received voice of the counter party is recorded in a voice memory of the memory unit 110 in step S519. The received voice signal may be a phone number of another party.

The controller 100 determines whether an instruction to terminate the recording mode is input in step S521. If not, the process returns to step S519 and records the received data. If so, the controller 100 reproduces the voice signal stored in the voice memory of the memory unit 110 and controls the voice processor 200 to recognize the voice, converts the recognized voice to characters, and displays the converted characters in step S523. In this case, operation of the voice processor 200 can be performed with the same method as that of the first embodiment. The phone number generated in the voice processor 200 is displayed in the display unit 140, thereby enabling the user of the mobile terminal to correct the displayed phone number through the key input unit 130.

The controller 100 determines whether a request for correcting the phone number is input in step S525. If so, the controller 100 corrects a character at which a cursor is positioned in step S527. Correction of the phone number is performed by positioning the cursor on a character in which an error exists and inputting character data to correct. The character correction process may also be performed at the time of calling communication, in which case the processes of steps S525 and S527 may be performed between steps S533 and S535.

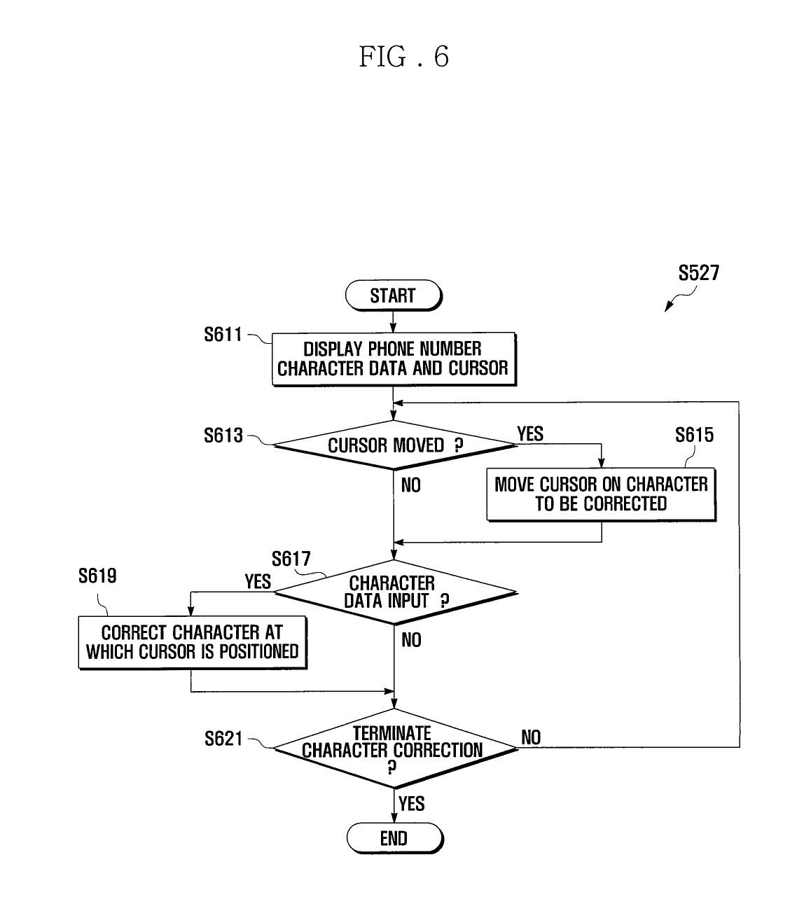

FIG. 6 illustrates a process of correcting a converted text at step S527 of the method of FIG. 5.

Referring to FIG. 6, when a request for correcting a character is input, the controller 100 controls the display unit 140 to display the phone number character data with a cursor in step S611.

The controller 100 determines whether a cursor is moved in step S613. If the cursor is moved, the user moves the cursor on a character to be corrected using the key input unit 130 in step S615.

The controller 100 determines whether character data is input by the key input unit 130 in step S617. If so, the controller 100 corrects the character at which the cursor is positioned in step S619.

The controller 100 determines whether character correction is terminated by the user in step S621. If character correction is not terminated, that is if a character is to be further corrected or if further characters are to be corrected, the process returns to step S613.

By repeatedly performing the above-described process, errors of generated phone number character data can be corrected.

If the controller 100 determines that character correction is terminated at step S621 through input by the user of a character correction termination instruction, the process returns to FIG. 5.

The controller 100 recognizes a recorded voice phone number while communicating, converts the recognized voice phone number to phone number character data, and displays the converted phone number character data. In this state, the controller 100 sustains a communication state. Therefore, error of a phone number may be corrected after step S531 of performing a communication service. Further, a process of steps S523 to S527 of converting to a character phone number after recording the received voice phone number may be performed after steps S529 and S531 of performing a communication service.

The controller 100 determines whether the communication service is terminated in step S529. If the communication service is not terminated, the controller 100 continues to perform the communication service in step S531. If the communication service is terminated, the controller 100 determines whether a request for calling communication is input by the user in step S533.

If a request for calling communication is input by the user, the controller 100 dials the converted phone number in step S535 and performs a calling communication service in step S537. Operation of performing a calling communication function using the converted character phone number may be performed before steps S529 and S531. In this case, if a request for calling communication is input by the user, the controller 100 may terminate a communication service, convert the character phone number data to a DTMF signal, and perform a dialing function and a calling communication service.

The controller 100 determines whether a request for terminating communication is input by the user in step S539. If a request for terminating communication is input, the controller 100 terminates the communication service and determines whether a request for storing the phone number in the phone book is input by the user in step S541.

If a request for storing the phone number in the phone book is input, the controller 100 receives the name of the owner of the dialed phone number from the user and stores the name and phone number in the phone book in step S543.

A process of registering the phone number in the phone book can be performed as in the process of FIG. 4.

As described above, in the second embodiment of the present invention, a voice phone number received from a counter party while communicating is recorded, the recorded voice phone number is recognized, the recognized phone number is converted to a character phone number, and the converted character phone number is displayed. When a request for correcting the displayed character phone number is input, an error can be corrected by replacing a character in which an error exists with an input character, and when a request for communication is input, the converted character phone number can be dialed and calling communication with another party can be performed.

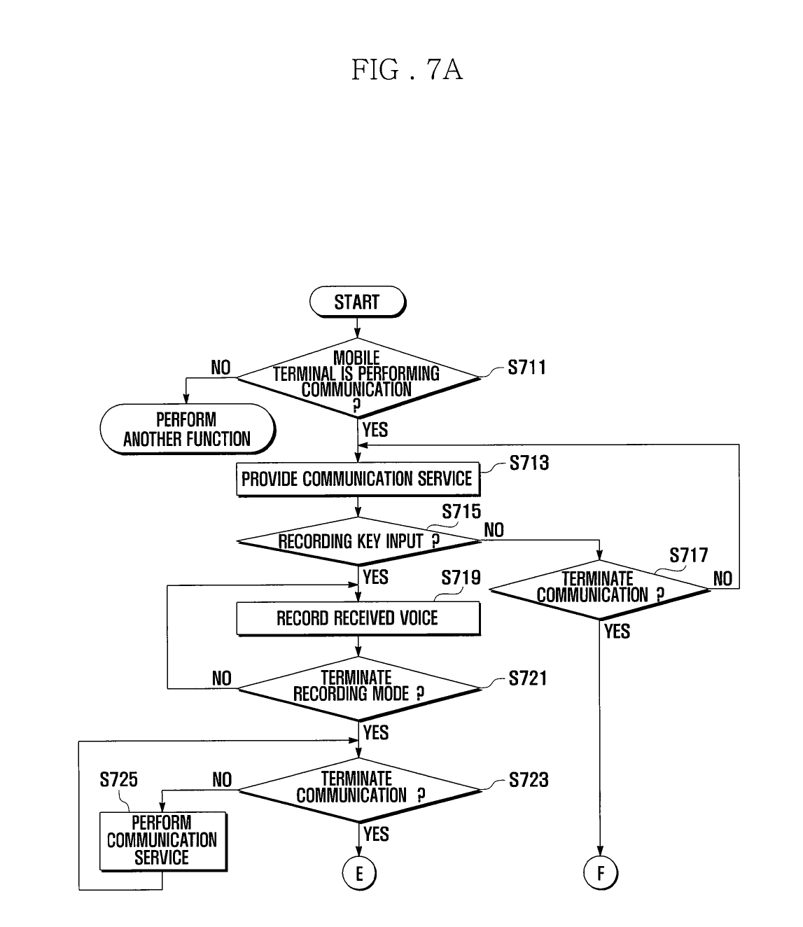

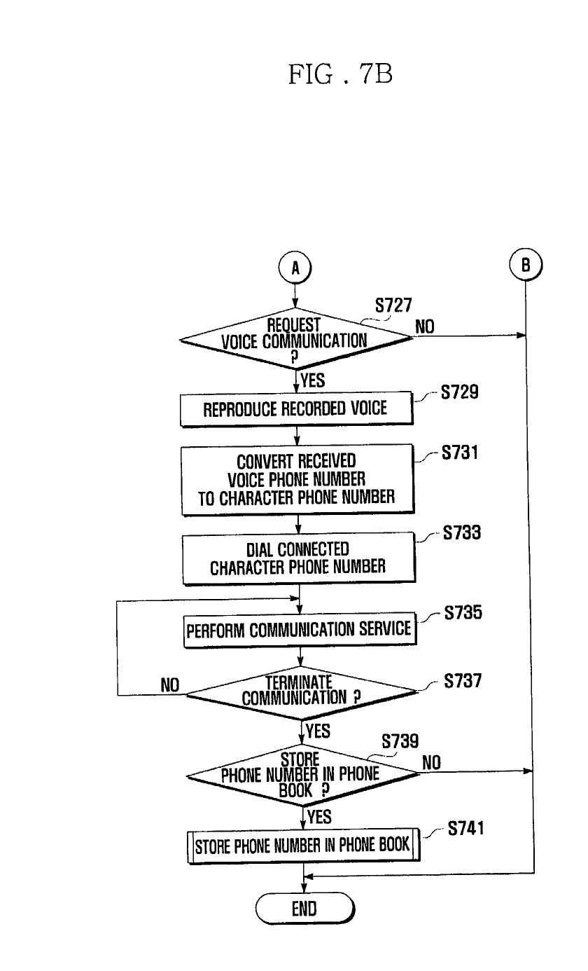

FIG. 7 illustrates a method of performing a voice communication service according to a third embodiment of the present invention.

Referring to FIG. 7, the controller 100 determines whether the mobile terminal is performing communication in step S711. If the mobile terminal is not performing communication, the corresponding function is performed. If the mobile terminal is performing communication, the controller 100 performs a communication service in step S713.

In a communication service state, the controller 100 determines whether a recording instruction is key input by the user in step S715. If a recording instruction is not key input, the controller 100 determines whether an instruction for terminating communication with a counter party is input in step S717. If so, the controller 100 terminates communication with the counter party. If not input, the process returns to step S713 and the controller 100 continues to perform the communication service.

If a recording instruction is input at step S715, the controller 100 records a received voice signal and stores he received voice signal in a voice memory of the memory unit 110 in step S719. The received voice signal may be a phone number of another party.

The controller 100 determines whether a terminate recording mode instruction is input in step S721. If so, the controller 100 terminates the recording operation and determines whether a communication termination instruction is input in step S723. If a communication termination instruction is not input, the controller 100 continues to perform a communication service with the counter party in step S725. If a communication termination instruction is input at step S723, the controller 100 determines whether a request for voice communication is input in step S727.

If a request for voice communication is input, the controller 100 reproduces the recorded voice phone number stored in the voice memory of the memory unit 110 in step S729.

In the third embodiment of the present invention, a voice phone number of another party is recorded while communicating, and when a request for voice calling communication is input, the recorded voice phone number is reproduced, and voice dialing is performed according to the reproduced voice phone number. Alternatively, if the user of the mobile terminal listens to the reproduced voice phone number and reproduces the corresponding phone number through the MIC, the controller 100 controls the voice processor 200 to convert the received voice phone number to a character phone number in step S731, converts the character phone number to a DTMF signal and performs dialing in step S733, and performs a calling communication function in step S735.

A voice phone number of another party recorded at step S719 can be generated in various forms. For example, when two adjacent numerals of a phone number are identical, for example “55”, the numerals may be referred to as “double five” or “five five”; when three adjacent numerals of a phone number are identical, for example “777”, the numerals may be referred to as “triple seven” or “seven seven seven”; and in four adjacent numerals of a phone number, for example “1427”, the numerals may be referred to as “fourteen twenty seven” or “one four two seven”. Further, a unit (for example, thousand or hundred) may be additionally referred to within a phone number, and a word such as a dash may also be referred to. Therefore, when phone numbers spoken by another party using various forms of expression are recognized, an error may be generated, and in this case, an error correcting process should be performed.

When a voice is generated with a preset method by a user of a mobile phone, efficiency of voice dialing can be improved. That is, when the user of the mobile phone speaks a phone number according to a preset rule, for example, if numerals of a phone number are spoken by voice, voice recognition efficiency can be improved. Further, because a voice of the user is recognized in voice recognition, recognition efficiency can be improved. In the third embodiment of the present invention, after a phone number is recorded while communicating, if a voice communication function is selected, the recorded phone number is reproduced, the reproduced phone number is input by the user of the mobile terminal through a MIC, and the input voice phone number is recognized, thereby performing a voice dialing function. Therefore, dialing efficiency can be improved by voice dialing.

In this case, because a voice signal of the user of the mobile terminal received through the MIC is a preset type of voice signal, operation of the information generator 230 is unnecessary. Therefore, the controller 100 recognizes the received voice phone number and performs an operation of converting the received voice phone number to a character at step S731, and applies a character phone number output from the character converter 220 to the DTMF generator 240 and controls to generate a DTMF signal of the phone number to be called at step S733.

After the dialing operation for performing calling communication is performed, upon detecting a response from a counter party, the controller 100 performs calling communication at step S735.

The controller 100 determines whether a request for terminating communication is input in step S737. If so, the controller 100 terminates the communication service and determines whether a request for storing the phone number in the phone book is input in step S739. If a request for storing the phone number is input, the controller 100 stores the dialed phone number in the phone book in step S741.

In the third embodiment of the present invention, a voice phone number received from a counter party while communicating is recorded, and when a request for voice communication is input, the recorded voice phone number is reproduced. When the voice phone number is received from the calling party of the mobile terminal, the received voice phone number is converted to a character phone number, which is dialed, and calling communication with another party having the character phone number can be performed.

As described above, according to the present invention, while communicating with a counter party, a phone number of another party can be recorded and a voice dialing function can be performed using the recorded voice phone number. By using a voice dialing function, a phone number of another party that is not known to the user can be received by a voice and an automatic dialing function can be performed, whereby communication performance can be improved.

Although preferred embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of performing communication in a mobile terminal, comprising:
recording a voice phone number of a second party while communicating with a first party;
reproducing the recorded voice phone number when a request for voice communication is input;
recognizing the reproduced voice phone number;
dialing the recognized voice phone number to call the second party; and
performing communication with the second party when the second party receives the call.

2. The method of claim 1, wherein the recording step further comprises selectively recording a portion of the voice phone number of the second party.

3. The method of claim 2, wherein the dialing step further comprises:
converting the recognized voice phone number to a character phone number;
converting the character phone number to a Dual-Tone Multi-Frequency (DTMF) signal; and
dialing the character phone number.

4. The method of claim 3, wherein converting the recognized voice phone number to a character phone number further comprises:
converting the recognized voice phone number to character data; and
removing character data that is not related to a numeral from the converted character data and analyzing the numeral and the character data not related thereto to generate a character phone number.

5. The method of claim 1, wherein the reproducing step further comprises releasing communication with the first party when a request for voice communication is input while communicating with the first party, and reproducing the recorded voice phone number.

6. The method of claim 5, wherein a request for voice communication is input after communication with the first party is released.

7. The method of claim 4, further comprising terminating communication with the second party and displaying the phone number of the second party in a phone book; and
registering input calling party information to the phone book together with the phone number, when a request for registering calling party information in a phone book is input.

8. The method of claim 7, wherein the registering step further comprises:
recognizing an input voice when the calling party information is input by the voice;
converting the recognized voice to character calling party information; and
registering the converted character calling party information,
wherein the calling party information includes a calling party name.

9. A method of performing communication in a mobile terminal, comprising:
recording a voice phone number of a second party while communicating with the first party;
reproducing the recorded voice phone number;
recognizing the reproduced voice phone number and converting the recognized phone number to a character phone number;
dialing the converted character phone number to call the second party when a request for voice communication is input; and
performing communication with the second party when the second party receives the call.

10. The method of claim 9, wherein the recording step further comprises selectively recording a portion of the voice phone number of the second party.

11. The method of claim 9, further comprising converting a voice phone number to a character phone number and displaying the converted character phone number; and
indicating a position of a character to be corrected according to selection by an input key and correcting, by inputting a character, a character at the indicated position.

12. The method of claim 9, wherein dialing the converted character phone number comprises:
converting the recognized voice phone number to a character phone number;
converting the character phone number to a Dual-Tone Multi-Frequency (DTMF) signal; and
dialing the character phone number.

13. The method of claim 12, wherein converting the recognized voice phone number to a character phone number further comprises:
converting the recognized voice phone number to character data; and
removing character data that is not related to a numeral from the converted character data and analyzing the numeral and the character data not related thereto to generate a character phone number.

14. The method of claim 9, wherein the reproducing step further comprises releasing communication with the first party when a request for voice communication is input while communicating with the first party, and reproducing the recorded voice phone number.

15. The method of claim 14, wherein a request for voice communication is input after communication with the first party is released.

16. A method of performing communication in a mobile terminal, comprising:
recording a voice phone number of a second party while communicating with the first party;
reproducing the recorded voice phone number when a request for voice communication is input;
recognizing the voice phone number of the second party input by a user of the mobile terminal through a microphone;
dialing the phone number of the second party to make a call; and
performing communication with the second party when the second party receives the call.

17. The method of claim 16, wherein the voice phone number is preset in the mobile terminal.

18. The method of claim 16, wherein the dialing step further comprises:
converting the recognized voice phone number to a character phone number;
converting the character phone number to a Dual-Tone Multi-Frequency (DTMF) signal; and
dialing the character phone number.

19. The method of claim 16, wherein the reproducing step further comprises releasing communication with the first party when a request for voice communication is input while communicating with the first party, and reproducing the recorded voice phone number.

20. The method of claim 19, wherein a request for voice communication is input after communication with the first party is released.
